(19) United States
(12) Patent Application Publication
(10) Pub. No.: US 2004/0225515 A1
(43) Pub. Date: Nov. 11, 2004

(54) System and method for managing export files

(76) Inventor: Po-Hsuan Wu, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/685,829

(22) Filed: Oct. 14, 2003

(30) Foreign Application Priority Data
May 7, 2003 (TW) 92112496

(51) Int. Cl. G06F 17/60

(52) U.S. Cl. 705/1; 705/8

(57) ABSTRACT

A system and method for generating export files based on basic export data obtained from a plurality of manufacturing databases, and for automatically sending shipping advices to corresponding consignees of cargoes by e-mail is provided. The system includes a database server (12) comprising a database (120), a plurality of client computers (16), a plurality of manufacturing workstations (10) and an application server (14). Each of the manufacturing workstations includes a manufacturing database (1000) for storing basic export data. The basic export data include information on cargoes, forwarders, and shipping paths. The application server is linked to the manufacturing workstations with an internal network (13), through which the application server obtains the basic export data by accessing the manufacturing databases on a daily basis. The application server includes a basic data module (141), a time control module (142), a tracking module (143), an export file management module (144) and a communication module (145). A related method is also disclosed.

### BACKGROUND OF THE INVENTION

1. Field of the Invention

The present invention relates to computerized logistic operation systems and methods, and particularly to a logistic operation system and method for managing export files.

2. Background of the Invention

Against the background of globalization of domestic economies, the rapid development of the logistics industry has brought profound changes to the global supply chain of enterprises that deal in commodities. Sophisticated IT (Information Technology) logistic systems are becoming an essential element for the management and operation of enterprise logistics. These systems increase operating efficiency, reduce costs, and improve customer service.

Traditional computerized export files management systems and methods generally depend on manual labor to input basic data on cargo and forwarders, with the basic data being stored in distributed personal computers. New configurations have emerged from recent developments in the logistics industry. For example, Taiwan Published Patent No. 518,496 released on Jan. 21, 2003 and entitled “System and method for managing export cargo” is exemplary in this regard. The system disclosed in this patent is implemented in a network that connects together partners located in different places of an enterprise. The system manages export cargo and export files after receiving data on purchase orders sent by customers. In addition, the system helps enterprises control production and surpluses of finished products and raw materials. However, the system does not deal with means for managing hardcopy purchase orders, nor sending of export data to consignees in time. Thus, a system and method for managing export files that overcomes the above-mentioned problems is desired.

### SUMMARY OF THE INVENTION

Accordingly, an object of the present invention is to provide an export file system and method for generating export files basic on basic export data obtained from a plurality of manufacturing databases, and for automatically sending shipping advices to corresponding consignees by e-mail.

To achieve the above-mentioned object, an export file management system of the present invention comprises: a plurality of manufacturing workstations, a database server comprising a database, an application server, an internal network connecting the manufacturing workstations and the application server, and a network linking the client computers to the application server. Each of the manufacturing workstations comprises a manufacturing database for storing basic export data. The application server comprises: a basic data module for obtaining the basic export data by accessing the manufacturing databases of the manufacturing workstations, and for storing said obtained data in the database; a tracking module for obtaining information on cargo tracking and abnormality messages sent by forwarders via the corresponding client computers; an export file management module for obtaining required data from the database; and for generating export files, address lists, cargo tracking records, and shipping advices based on said required data; and a communication module for receiving shipping advices, obtaining information on consignees of the cargo by accessing corresponding address lists in the database, and for sending the shipping advices to corresponding consignees according to said obtained information on consignees. Each of the shipping advices is used for informing a corresponding consignee of up-to-date details of a cargo once the cargo is delivered to the consignee. Each of the shipping advices comprises an invoice number, basic information on the cargo, information on forwarders, a shipping path, an arrival time to the destination port, and a flight/voyage number, and has a series of export files attached thereto. The export files comprise a packing list, a pro forma invoice, and a bill of lading. The address lists are used for recording recipients of reports and consignees of cargoes. The export file management module is used for accessing the database on a predetermined schedule to obtain cargo tracking records and basic export data, for generating reports based on said obtained matters, and for sends the reports and the shipping advices to the communication module, wherein the reports comprise an on way tracking report for describing information on delivery between original ports and respective destination ports, an abnormality report comprising information on any delayed cargoes, and a booking status report for showing booking statuses of orders. The communication module is used for receiving reports sent by the export file management module, obtaining information on recipients of the reports, and sending the reports according to said information on recipients.

Further, the present invention provides an export file management method comprising the steps of: (a) obtaining basic export data on a cargo by accessing a manufacturing database; (b) storing the basic export data in a system database; (c) obtaining the basic export data from the system database to generate a series of export files, an address list and a cargo tracking record; (d) receiving information on cargo tracking and abnormality messages from a client computer of a corresponding forwarder, and storing said received information in the system database; (e) obtaining the basic export data, the information on cargo tracking and the export files by accessing the system database, and generating a shipping advice; (f) obtaining information on a corresponding consignee of the cargo by accessing the address list of the system database, and sending the shipping advice to the consignee based on the obtained information; (g) generating reports on a plurality of cargoes by accessing the information on cargo tracking and the basic export data in the system database; and (h) obtaining information on corresponding recipients of the reports by accessing the address list of the system database, and sending the reports to the recipients based on the obtained information on a predetermined schedule.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of an application environment of an export file management system in accordance with a preferred embodiment of the present invention;

FIG. 2 is a diagram of software infrastructure of the export file management system of FIG. 1, but showing only one client computer thereof; and

FIG. 3 is a flowchart of preferred operation of the export file management system of FIG. 1.

### DETAILED DESCRIPTION OF THE INVENTION

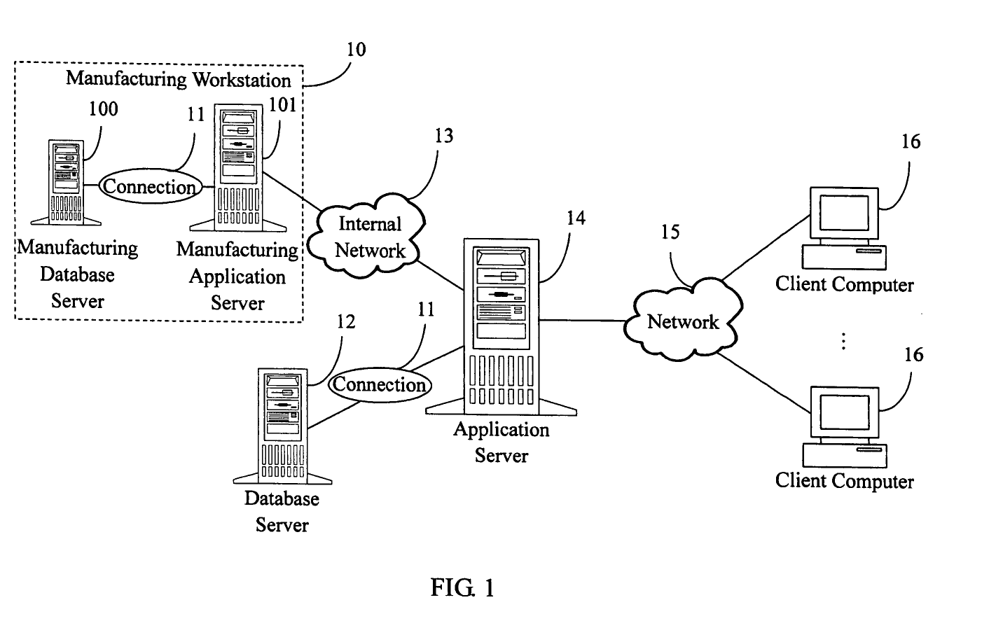

FIG. 1 is a schematic diagram of an application environment of an export file management system (“the system”) in accordance with the preferred embodiment of the present invention. The system comprises a plurality of manufacturing workstations 10 (only one shown), a database server 12, an application server 14, and a plurality of client computers 16. Each manufacturing workstation 10 comprises a manufacturing database server 100, a manufacturing application server 101, and a connection 11 interconnecting the manufacturing database server 100 and the manufacturing application server 101. The connection 11 is connectivity such as ODBC (Open Database Connectivity) or JDBC (Java Database Connectivity). The manufacturing workstations 10 are linked to the application server 14 via an internal network 13, which may for example be an intranet. The application server 14 is connected with the database server 12 through another connection 11, and is linked to the client computers 16 via a network 15. The network 15 can be an intranet or the Internet, through which the application server 14 can send reports and shipping advices to the client computers 16. Said reports comprise three kinds of reports, namely: an on way tracking report that includes information on delivery between original ports and respective destination ports; an abnormality report comprising information on any delayed cargoes; and a booking status report for showing booking statuses of orders. Each shipping advice is used for informing a relevant consignee of up-to-date details of a cargo once the cargo is delivered to the consignee. Each shipping advice comprises data for invoice number, basic information on cargo, information on forwarders, shipping path, arrival time at destination port, and flight/voyage number. Each shipping advice also has a series of export files attached thereto. In the preferred embodiment of the present invention, the export files comprise a packing list, a pro forma invoice, and a bill of lading.

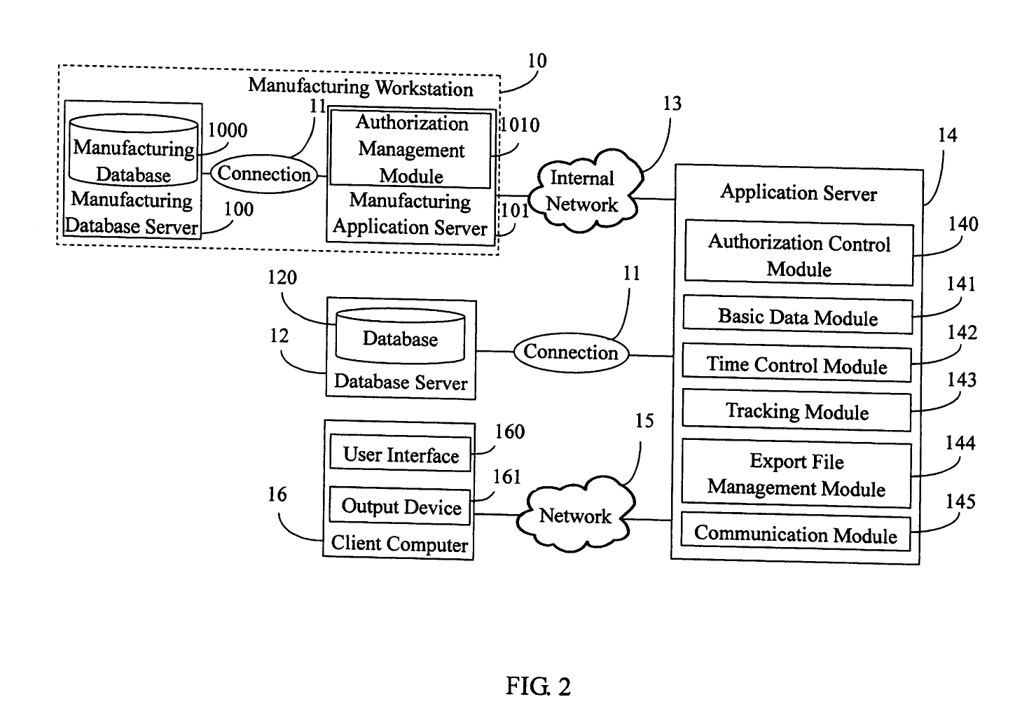

FIG. 2 is a block diagram of software infrastructure of the system of FIG. 1, but showing only one client computer 16. The manufacturing database server 100 comprises a manufacturing database 1000 for storing basic export data. The basic export data comprise information on cargoes, forwarders, and shipping paths. The manufacturing application server 101 comprises an authorization management module 1010, for defining operational rights and a scope of access for each user of the manufacturing workstation 10. The database server 12 comprises a database 120 for storing the basic export data, address lists, export files, and cargo tracking records. The address lists are used for recording consignees of cargoes and recipients of reports. Each cargo tracking record comprises columns for: packing number, information on shipping path, information on cargo tracking, and abnormality messages. The information on cargo tracking comprises an actual arrival time and an actual departure time for each port through which a cargo has passed, a system status, a shipping status, and a current position of the cargo. The system status indicates a status of whether and how the system is dealing with the cargo. The shipping status provides details on cargo the system is dealing with. The abnormality messages record any time delay resulting from causes such as bad weather or human error. The client computer 16 comprises a user interface 160 and an output device 161. The user interface 160 provides an interactive interface for carrying out operations such as adding, modifying, or deleting basic data.

The application server 14 comprises an authorization control module 140, a basic data module 141, a time control module 142, a tracking module 143, an export file management module 144, and a communication module 145. The authorization control module 140 defines operational rights and a scope of access for each user of the system. The basic data module 141 is used for adding, modifying, and deleting basic data. Said basic data comprise the basic export data, address lists, export files, and cargo tracking records. The time control module 142 is used for setting three time parameters: first for defining when and how often the basic data module 141 accesses the manufacturing databases 1000 of the manufacturing workstations 10; second for defining when and how often the export file management module 144 accesses the database 120 to generate a series of export files; and third for defining when and how often the communication module 145 sends a series of reports. The tracking module 143 is used for obtaining information on cargo tracking and abnormality messages from the client computers 16, and for storing said obtained matters in the cargo tracking records of the database 120. The export file management module 144 is used for obtaining basic export data, by accessing the database 120; for generating export files, address lists and cargo tracking records based on said basic export data; and for storing said generated matters in the database 120. The export file management module 144 is further used for obtaining information on cargoes, shipping paths, invoice numbers, arrival times at destination ports, flight/voyage numbers and export files, by accessing the database 120; for generating shipping advices according to said obtained matters; and for sending the shipping advices to the communication module 145. In addition, the export file management module 144 accesses cargo tracking records and basic export data in the database 120 via the connection 11 according to a fixed schedule, generates reports based on said matters, and sends the reports to the communication module 145. In the preferred embodiment of the present invention, the fixed schedule is once per day, and three reports are generated: an on way tracking report, an abnormality report, and a booking status report. These reports are described in more detail above. The communication module 145 is used for receiving the shipping advice and the reports sent by the export file management module 144, for obtaining information on corresponding recipients by accessing address lists in the database 120, and for sending the shipping advices and the reports to the recipients according to said obtained information.

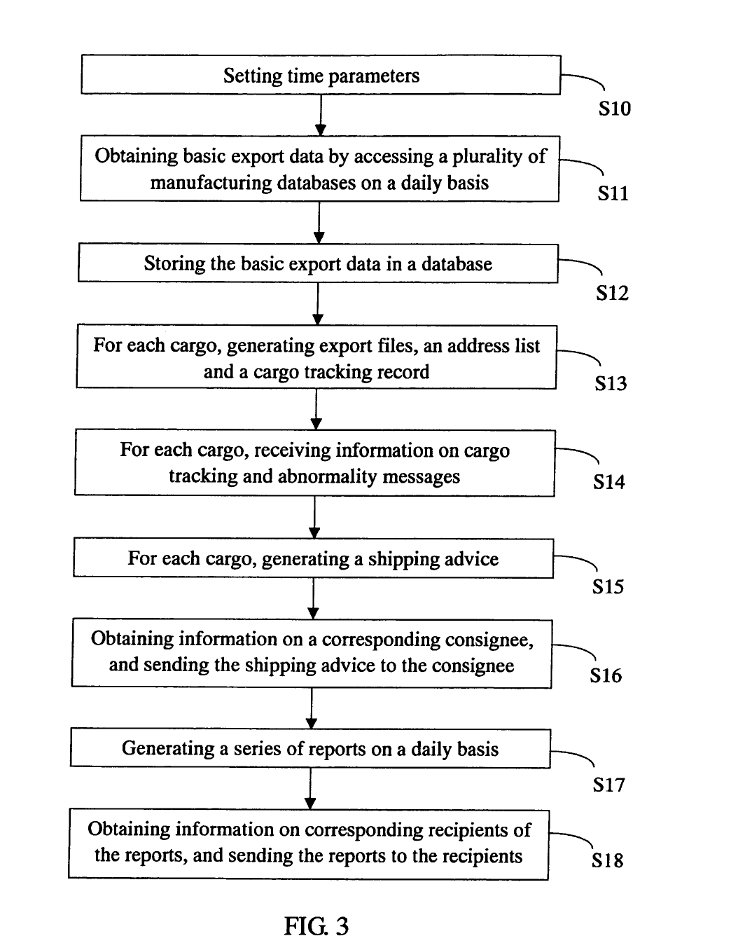

FIG. 3 is a flowchart of preferred operation of the system. In step S10, an operator sets said three time parameters via the time control module 142 of the application server 14. In step S11, the basic data module 141 accesses the manufacturing databases 1000 of the manufacturing workstations 10 on a daily basis to obtain basic export data. The basic export data comprise information on cargoes, forwarders, and shipping paths. In step S12, the basic data module 141 stores the basic export data in the database 120. In step S13, the export file management module 144 accesses the database 120 to obtain the basic export data; for each cargo, generates a series of export files, an address list and a cargo tracking record; and stores said generated matters in the database 120. In step S14, for each cargo, the tracking module 143 receives information on cargo tracking and abnormality messages sent by corresponding forwarders via the network 15, and stores the information on cargo tracking and abnormality messages in the corresponding cargo tracking record of the database 120. The information on cargo tracking comprises an actual arrival time and an actual departure time for each port through which a cargo has passed, a system status, a shipping status and a current position of the cargo. After cargo tracking is completed, in step S15, the export file management module 144 accesses the database 120; for each cargo, obtains the information on the cargo, the shipping path, the invoice number, the arrival time at the destination port, the flight/voyage number, and the export files; generates a corresponding shipping advice based on said obtained matters; and sends the shipping advice to the communication module 145. In step S16, the communication module 145 receives the shipping advice sent by the export file management module 144, obtains information on a corresponding consignee of the cargo by accessing the address list in the database 120, and automatically sends the shipping advice to the consignee of the cargo by e-mail based on said obtained information. In step S17, the export file management module 144 accesses cargo tracking records and information on cargoes in the database 120 on a daily basis, generates a series of reports for a particular day, and sends the reports to the communication module 145. Said reports for each day are an on way tracking report, an abnormality report, and a booking status report. These reports are described in more detail above. In step S18, the communication module 145 receives the reports sent by the export file management module 144 for the particular day, obtains information on corresponding recipients by accessing the corresponding address list in the database 120, and sends the reports to the recipients based on said information on recipients.

In general, the system and method of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention, which is defined by the claims appended hereto and allowable equivalents thereof.

What is claimed is:

1. An export file management system for generating export files based on basic export data obtained from a plurality of manufacturing databases, and for automatically sending shipping advices to corresponding consignees of cargoes by e-mail, the system comprising:
a plurality of manufacturing workstations;
a database server comprising a database;
an application server comprising:
a basic data module for obtaining basic export data by accessing the manufacturing workstations, and for storing said obtained basic export data in the database;
a tracking module for obtaining information on cargo tracking and abnormality messages sent by forwarders via corresponding client computers;
an export file management module for obtaining required data from the database; and for generating export files, address lists, cargo tracking records, and shipping advices based on said required data; and
a communication module for receiving shipping advices, obtaining information on consignees of cargoes by accessing corresponding address lists in the database, and for sending the shipping advices to the consignees according to said obtained information on consignees; and
a network connecting the manufacturing workstations and the application server.

2. The system according to claim 1, wherein the database is used for storing information on cargoes, information on forwarders, address lists, export files, and cargo tracking records.

3. The system according to claim 1, wherein each of the manufacturing workstations comprises:
a manufacturing database server comprising a manufacturing database for storing the basic export data; and
a manufacturing application server comprising an authorization management module for defining operational rights and a scope of access for each user of the manufacturing workstation.

4. The system according to claim 1, wherein for each of the cargo, the export files comprise a packing list, a pro forma invoice, and a bill of lading.

5. The system according to claim 1, wherein the information on cargo tracking comprises an actual arrival time and an actual departure time for each port through which a cargo has passed, a system status, a shipping status and a current position of the cargo.

6. The system according to claim 1, wherein the required data comprises basic export data, information on a cargo, a shipping path, an invoice number, an arrival time at a destination port, and a flight or voyage number.

7. The system according to claim 1, wherein the export file management module is used for accessing the database on a predetermined schedule to obtain cargo tracking records and basic export data, and for generating reports based on said obtained tracking records and basic export data.

8. The system according to claim 7, wherein on each occasion of said accessing, the reports comprise an on way tracking report for describing information on delivery between original ports and respective destination ports, an abnormality report comprising information on any delayed cargoes, and a booking status report for showing booking statuses of orders.

9. The system according to claim 1, wherein the address lists are used for recording recipients of reports and the consignee of cargoes.

10. The system according to claim 1, wherein each of the shipping advices is used for informing a corresponding consignee of up-to-date details of a cargo once after the cargo is delivered to the consignee, and comprises an invoice number, basic information on the cargo, information on forwarders, a shipping path, an arrival time at the destination port, and a flight or voyage number.

11. The system according to claim 10, wherein generated export files are attached to each of the shipping advices.

12. The system according to claim 7, wherein the export file management module is further used for sending the reports and the shipping advices to the communication module.

13. The system according to claim 1, wherein the communication module is used for receiving reports sent by the export file management module, obtaining information on recipients of the reports, and sending the reports according to said information on recipients.

14. The system according to claim 7, wherein the application server further comprises a time control module for setting a first time parameter, a second time parameter and a third time parameter, wherein:
the first time parameter defines times at which the basic data module accesses the manufacturing databases of the manufacturing workstations;
the second time parameter defines times at which the export file management module accesses the database to generate series of export files; and
the third time parameter defines times at which the communication module sends the reports.

15. An export file management method for generating export files based on basic export data obtained from a manufacturing database, and for automatically sending a shipping advice to a corresponding consignee of a cargo by e-mail, the method comprising the steps of:
(a) obtaining basic export data on the cargo by accessing the manufacturing database;
(b) storing the basic export data in a system database;
(c) obtaining the basic export data from the system database to generate a series of export files, an address list and a cargo tracking record;
(d) receiving information on cargo tracking and abnormality messages from a client computer of a corresponding forwarder, and storing said received information in the system database;
(e) obtaining the basic export data, the information on cargo tracking and the export files by accessing the system database, and generating a shipping advice; and
(f) obtaining information on a corresponding consignee of the cargo by accessing the address list of the system database, and sending the shipping advice to the consignee based on the obtained information.

16. The method according to claim 15, wherein the basic export data comprise information on the cargo, one or more forwarders and a shipping path.

17. The method according to claim 15, wherein step (a) further comprises the step of:
(a1) setting a first time parameter which defines times at which the manufacturing database is accessed;
(a2) setting a second time parameter which defines times at which the system database is accessed; and
(a3) setting a third time parameter which defines times at which reports are sent.

18. The method according to claim 15, further comprising the steps of:
(g) generating reports on a plurality of cargoes by accessing the information on cargo tracking and the basic export data in the system database; and
(h) obtaining information on corresponding recipients of the reports by accessing the address list of the system database, and sending the reports to the recipients based on the obtained information.

19. The method according to claim 18, wherein the reports comprise: an on way tracking report for describing information on delivery between original ports and respective destination ports, an abnormality report comprising information on any delayed cargoes, and a booking status report for showing booking statuses of orders.

20. A method of managing export files, comprising steps of:
setting time parameters;
obtaining basic export data from manufacturing databases on a daily basis;
generating export files and a cargo tracking record for each cargo;
receiving information on cargo tracking and abnormality messages for each cargo;
generating a shipping advice;
sending the shipping advice to a corresponding consignee;
generating a series of reports on a daily basis;
sending the reports to corresponding recipients.
